(19) United States
(12) Patent Application Publication
(10) Pub. No.: US 2020/0209103 A1
(43) Pub. Date: Jul. 2, 2020

(54) STRUCTURAL HEALTH MONITORING

(71) Applicants: Eyal Barmaimon, Haifa (IL); Shai Finkman, Haifa (IL); Lior Shtram, Tel Aviv (IL); Nadav Cohen, Haifa (IL)

(72) Inventors: Eyal Barmaimon, Haifa (IL); Shai Finkman, Haifa (IL); Lior Shtram, Tel Aviv (IL); Nadav Cohen, Haifa (IL)

(21) Appl. No.: 16/377,336

(22) Filed: Apr. 8, 2019

Related U.S. Application Data
(60) Provisional application No. 62/787,096, filed on Dec. 31, 2018.

(51) Int. Cl. G01M 7/02

(52) U.S. Cl. CPC G01M 7/025; G01M 7/022

(57) ABSTRACT

A system comprising a device and a monitoring unit configured to monitor the mechanical health of the device is disclosed. The monitoring unit may comprise at least one actuator, at least one sensor and at least one processing resource. The at least one actuator may be configured to vibrate the device and the at least one sensor may be configured to detect a corresponding output of the device. The at least one processing resource may be configured to process the output detected by the at least one sensor and to assess the mechanical health of the device by comparing the detected output of the device to a healthy fingerprint of the device, wherein the healthy fingerprint is an output of the particular device being tested when it is free of mechanical defects.

### CROSS REFERENCE TO RELATED APPLICATION

This application claims the benefit of U.S. Provisional Application No. 62/787,096 having a filing date of Dec. 31, 2018, which is incorporated by reference as if fully set forth.

### BACKGROUND

Many devices require mechanical integrity for its function and reliability. As such, it is beneficial to have testing mechanisms in place for monitoring the mechanical health of these devices. Current testing mechanisms for monitoring the mechanical health of devices are not ideal, as they are typically external to the device and not designed for a particular type of device, and expensive. Further, these monitoring systems are generally operated manually from time to time, with no synchronization to the device itself. Built-in tests are useful because they enable a device to test itself. Although, built-in tests are common in electronics and software, they are rarely found in mechanicals. As such, it would be desirable to have low cost built-in test design suitable for use with a variety of devices that may experience mechanical defects and wear.

### SUMMARY

A system comprising a device and a monitoring unit configured to monitor the mechanical health of the device is disclosed. The monitoring unit described herein may be low-cost and suitable for use with smaller and relatively inexpensive devices. The monitoring unit may comprise at least one actuator, at least one sensor and at least one processing resource. The at least one actuator may be configured to vibrate the device and the at least one sensor may be configured to detect an output of the device. In an embodiment, the at least one actuator and the at least one sensor may comprise a single unit. The at least one processing resource may be configured to process the output detected by the at least one sensor. The at least one processing resource may be further configured to assess the mechanical health of the device by comparing the detected output of the device to a healthy fingerprint of the device, wherein the healthy fingerprint is an output of the particular device being tested when it is free of mechanical defects. The monitoring unit may be integrated with the device and therefore act as a built-in test for the device.

### BRIEF DESCRIPTION OF THE DRAWINGS

FIGS. 1A-1C are illustrations of a piezoelectric transducer in various states;

FIG. 2 is an illustration of an embodiment of a monitoring system in accordance with the present disclosure;

FIG. 3 is an illustration of an embodiment of a monitoring system in accordance the present disclosure;

FIG. 4 is an illustration of an embodiment of a monitoring system in accordance the present disclosure;

FIG. 5 is a block diagram illustrating components of a monitoring unit in accordance with the present disclosure;

FIG. 6 is a graphical representation of a comparison of an output of a device in a current state to a healthy fingerprint of the device;

FIG. 7A is an unhealthy visual indication on a display device according to an embodiment;

FIG. 7B is an healthy visual indication on a display device according to an embodiment;

FIG. 8 is a flowchart of a method for monitoring the mechanical health of a device in accordance with the present disclosure; and

FIG. 9 is a flowchart of a method for determining a healthy fingerprint of a particular device in accordance with the present disclosure.

### DETAILED DESCRIPTION OF THE PREFERRED EMBODIMENTS

Examples of different monitoring units and methods for detecting the presence or absence of a mechanical defect of a device will be described more fully herein with reference to the accompanying drawings. These examples are not mutually exclusive, and features found in one example can be combined with features found in one or more other examples to achieve additional implementations. Accordingly, it will be understood that the examples shown in the accompanying drawings are provided for illustrative purposes only and they are not intended to limit the disclosure in any way. Like numbers refer to like elements throughout.

Described herein are methods and apparatuses for monitoring the mechanical health of a device. A system in accordance with the present disclosure may comprise a device to be tested and a monitoring unit. The monitoring unit may comprise at least one actuator configured to vibrate the device, at least one sensor configured to detect an output of the device, and at least one processing resource configured to process the output detected by the at least one sensor. The at least one processing resource may be further configured to assess the mechanical health of the device by comparing the detected output of the device to a healthy fingerprint of the device, wherein the healthy fingerprint is an output of the particular device being tested when it is free of mechanical defects.

In an embodiment, the at least one processing resource may be coupled to the device. In a further embodiment the at least one processing resource is a dedicated processor integrated with the device. In an alternate embodiment, the at least one processing resource 203 is external to the device. In a further embodiment, the at least one processing resource 203 may be an external processor located external to the device (not shown).

In an embodiment, the monitoring unit may further comprise a stimulation source configured to provide a stimulation signal to the at least one actuator. In a further embodiment, the stimulation source may provide a sinusoidal voltage to the at least one actuator. Additionally or alternatively, the stimulation source may provide an impulse input, step input, linear chirp function, non-linear chirp function, desecrate sine sweep, or any other actuation that achieves the desired bandwidth.

In an embodiment, the at least one actuator may comprise a piezoelectric transducer. Alternatively, the at least one actuator may comprise an electrostatic actuator, an electromagnetic actuator or a magnetoresistive actuator. However, as will be appreciated by a person having ordinary skill in the art, this list is meant to be illustrative and not exhaustive, and the at least one actuator may comprise various other actuator types. In an embodiment, the at least one sensor may comprise a piezoelectric transducer.

In an embodiment, the at least one actuator and the at least one sensor may comprise a single unit. For example, the at least one actuator and the at least one sensor may comprise a single piezoelectric transducer.

In an embodiment, the processing resource may be configured to assess the mechanical health of the device by applying an algorithm comparing the output of the device against a healthy fingerprint of the particular device. The healthy fingerprint may be an output of the particular device when the device is free of mechanical defects. Additionally or alternatively, the healthy fingerprint may be a transfer function matrix (i.e., an output normalized by an input in the frequency domain) of the particular device to be tested. In a further embodiment, the algorithm may produce a pass-fail result. A fail result may indicate that there is a high probability that the device has one or more mechanical defects. In an even further embodiment, the monitoring unit may further comprise a display device configured to display the pass-fail result.

In an embodiment, the monitoring unit may be configured to go into a run mode during power up and/or periodically during use. Additionally or alternatively, in an embodiment, the monitoring unit is configured to go into run mode when commanded by an input. In an embodiment, the locations of the at least one actuator and the at least one sensor are optimized. For example, in an embodiment, the at least one actuator and the at least one sensor are disposed on the device such that the most accurate output of the device is detected. Further, the at least one actuator may be disposed such that the likelihood of the at least one actuator failing to sense a mechanical defect is reduced.

A method in accordance with the present disclosure may comprise activating at least one actuator configured to cause the device to vibrate, detecting the output of the device via at least one sensor, processing the output detected by the at least one sensor via at least one processing resource, and assessing the mechanical health of the device based on the detected output via the at least one processing resource.

In an embodiment, activating the at least one actuator may comprise providing a stimulation signal to the at least one actuator via a stimulation source. In a further embodiment, activating the at least one actuator may comprise providing a sinusoidal voltage via the stimulation source. Additionally or alternatively, activating the at least one actuator may comprise providing an impulse input, step input, linear chirp function, non-linear chirp function, desecrate sine sweep, or any other actuation that achieves the desired bandwidth, via the stimulation source. In an embodiment, determining the presence or absence of a mechanical defect may comprise applying, via the at least one processing resource, an algorithm comparing the output of the device to against a healthy fingerprint of the particular device, wherein the healthy fingerprint is an output of the device when the device is free from mechanical defects. In a further embodiment, the algorithm may comprise comparing at least one of the amplitude change, damping change, peak split, frequency shift and phase shift of the device in a current state against a healthy fingerprint of the device.

In an embodiment, the method further comprises retrieving the algorithm and the healthy fingerprint of the device from a memory. In an embodiment, the algorithm may produce a pass-fail result. In a further embodiment, the method further comprises displaying the pass-fail result on a display device.

A method for determining a healthy fingerprint of a particular device to be tested may comprise performing the following steps on the device when it is free of mechanical defects: activating at least one actuator configured to cause the device to vibrate, detecting an output of the device via at least one sensor, processing the output detected by the at least one sensor via at least one processing resource, and establishing, via the processing resource, the output as a healthy fingerprint of the particular device. The output of the healthy device may be established as the healthy fingerprint manually by the user using one or more input devices. The method may further comprise storing the healthy fingerprint of the device in a memory so that it may be retrieved and compared to the detected output of the device in a current state. As such, the healthy fingerprint may be a unique signature of a particular device. This allows the monitoring unit 200 to be configured for use with a variety of devices. A system in accordance with the present disclosure uses resonant inspection to assess the mechanical health of a device. Resonant inspection operates by analyzing the whole-body resonances of a device. The resonant frequencies of a device are determined, in part, by the size and stiffness of the device. As such, changes in a device's dimensions and/or stiffness will change its resonant frequencies. The stiffness of a device is affected by the elastic properties of the device's material(s), as well as the presence of mechanical defects. As such, changes in the elastic properties of the device's material(s) and the presence of mechanical defects will affect the resonant frequencies of the device. Therefore, changes in the elastic properties of the device's material(s) and the presence of mechanical defects are detectable through the resonance frequencies of the device. As such, resonant inspection uses resonance frequencies of a device to monitor a device's mechanical integrity. Resonant inspection may be sensitive to cracks, chips, holes, porosity, out-of-tolerance dimensions, residual stress, as well as bonding, welding and brazing failures.

In general, resonant inspection involves coupling actuators and sensors to the device to be tested. The actuators excite the unit, causing it to vibrate. The sensors then measure the amplitude and/or phase of the vibration. The output data may be used to assess the mechanical integrity of the device.

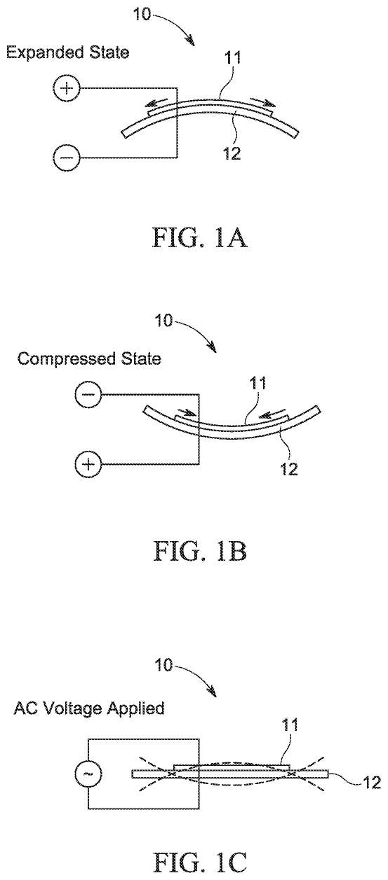

With reference to FIGS. 1A-1C, actuators and sensors used in resonance inspection may comprise piezoelectric transducers 10. A piezoelectric transducer 10 is generally comprised of a piezoelectric element 11 and a metal plate 12 held together by an adhesive. The piezoelectric element 11 may comprise a piezoelectric material. A first side of the piezoelectric element 11 may contain an electrode for electrical conduction. A second side opposite the first side of the piezoelectric element 11 may also contain an electrode for electrical conduction.

With reference to FIGS. 1A and 1B, when an alternating voltage is applied to the piezoelectric ceramic element 11, the piezoelectric ceramic element 11 may expand and shrink diametrically, as shown in FIGS. 1A and 1B, respectively, due to the Poisson effect. The metal plate 12, on the other hand, does not expand, thereby causing the piezoelectric transducer 10 as a whole to bend. Further, if the piezoelectric ceramic element 11 is directly attached to a surface, the effect would be similar. For example, if the piezoelectric ceramic element 11 is attached to a plastic housing, the housing could serve the same purpose as the metal plate. With reference to FIG. 1C, an alternating voltage input, such as an alternating AC voltage input, may be applied to the piezoelectric transducer 10. When the piezoelectric transducer 10 is attached to an enclosed surface, the surface may vibrate at the same frequency.

If the surface is vibrating while no voltage input is being applied to the piezoelectric transducer 10, the vibration may expand and shrink the piezoelectric transducer 10 due to the piezoelectric effect. As a result, an alternating voltage potential may be created on the piezoelectric transducer's 10 electrodes. As such, the piezoelectric transducer 10 may also act as a sensor.

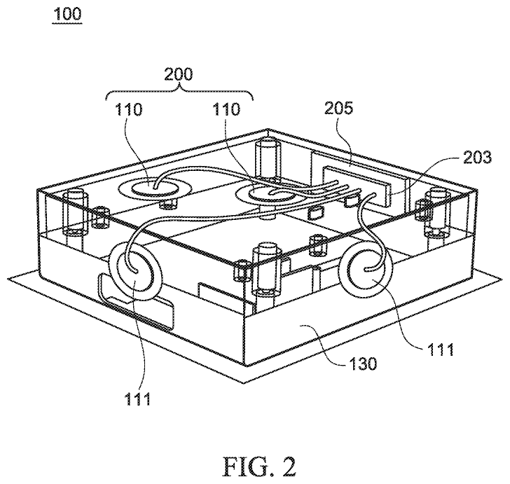

With reference to FIGS. 2, 3 and 4, a system 100 comprising a device 130 and a monitoring unit 200 for monitoring the mechanical health of the device 130 is shown. The device 130 may be a variety of mechanical devices, including smaller and relatively inexpensive mechanical devices. For example, the device may be a medical device, such as an IV pump, or a household device, such as a microwave.

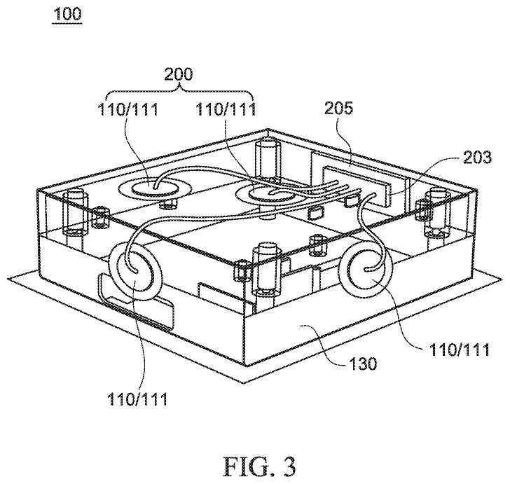

The monitoring unit 200 for monitoring the mechanical health of the device 130 may comprise at least one actuator 110, at least one sensor 111 and at least one processing resource 203. In an embodiment, the at least one actuator 110 and the at least one sensor 111 may be separate units, as shown in FIG. 2. Alternatively, the at least one actuator 110 and the at least one sensor 111 may comprise a single unit 110/111, as shown in FIG. 3.

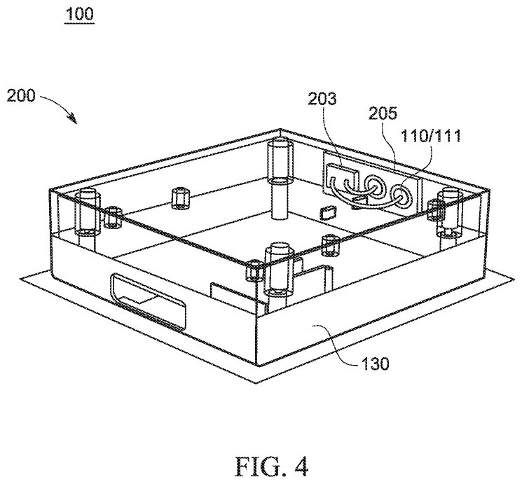

In an embodiment, the at least one actuator 110, the at least one sensor 111 and the at least one processing resource 203 may be located throughout the device, as shown in FIGS. 2 and 3. For example, the monitoring unit 200 may comprise multiple actuator and sensor units 110/111 and at least one processing unit 203 coupled to the device 130. In an embodiment, the at least one processing unit 203 is enclosed in a monitoring box 205. Alternatively, the at least one actuator 110, at least one sensor 111 and at least one processing resource 203 may be enclosed in the monitoring box 205, as shown in FIG. 4.

In an embodiment, the at least one processing resource 203 may be coupled to the device, as shown in FIGS. 2, 3 and 4. In a further embodiment the at least one processing resource 203 is a dedicated processor integrated with the device 130. In an alternate embodiment, the at least one processing resource 203 is external to the device (not shown). For example the at least one processing resource 203 may be an external processor located external to the device (not shown).

In an embodiment, the at least one actuator 110 may comprise a piezoelectric transducer. Alternatively, the at least one actuator may comprise an electrostatic actuator, an electromagnetic actuator or a magnetoresistive actuator. However, as will be appreciated by a person having ordinary skill in the art, this list is meant to be illustrative and not exhaustive, and the at least one actuator may comprise various other actuator types.

In an embodiment, the at least one sensor 111 may be a piezoelectric transducer. In an embodiment, both the at least one actuator 110 and the at least one sensor 111 may be a piezoelectric transducer. In a further embodiment, the at least one actuator 110 and the at least one sensor 111 may be a single piezoelectric transducer unit 110/111. The single piezoelectric transducer unit 110/111 may comprise a piezoelectric transducer 10 as described with respect to FIGS. 1A-1C.

The at least one actuator 110 may be configured to cause the device 130 to vibrate when the actuator is activated. The at least one sensor 111 may be coupled to the device 130 and configured to measure an output of the device 130. For example, the at least one sensor 111 may measure the amplitude of the output of the device 130. Additionally or alternatively, the at least one sensor 111 may measure the frequency change of the output of the device 130.

In an embodiment, the at least one actuator 1110 may comprise a plurality of actuators and the at least one sensor 111 may comprise a plurality of sensors. The number of actuators and the number of sensors may be optimized for the size and shape of the device 130. Further, the location of the at least one actuator 110 and the at least one sensor 111 may be optimized for the size and shape of the device 130. For example, in an embodiment, the at least one actuator 110 and the at least one sensor 111 are disposed on the device 130 such that the most accurate output of the device 130 is detected. Further, the at least one actuator 110 may be disposed such that the likelihood of the at least one actuator 110 failing to sense a mechanical defect is reduced.

The monitoring unit 200 may comprise a stimulation source (not shown). The stimulation source may be coupled to the at least one actuator 110 and configured to supply a stimulation signal to the at least one actuator 110. In an embodiment, the stimulation source may provide a sinusoidal voltage to the at least one actuator 110. Additionally or alternatively, the stimulation source may provide an impulse input, step input, linear chirp function, non-linear chirp function, desecrate sine sweep, or any other actuation that achieves the desired bandwidth.

The at least one processing resource 203 may be configured to send a signal to activate the at least one actuator 110. For example, the at least one processing resource 203 may send a signal to the stimulation source to provide a stimulation signal to the at least one actuator 110, thereby activating the at least one actuator 110. The at least one actuator 110 and/or the stimulation source may be in wired communication with the at least one processing resource 203.

The measurements detected by the at least one sensor 111 may be communicated to the at least one processing resource 203. In an embodiment, the at least one sensor 111 may be in wired communication with the at least one processing resource 203.

The at least one actuator 110 may be connected to the at least one processing resource 203 via a wire and the at least one sensor 111 may be connected to the at least one processing resource 203 via separate wires, as shown in FIG. 2. In an embodiment where the at least one sensor and the at least one transducer comprise a single unit 110/111, the single unit 110/111 may be connected to the at least one processing resource 203 via a single wire, as shown in FIG. 3.

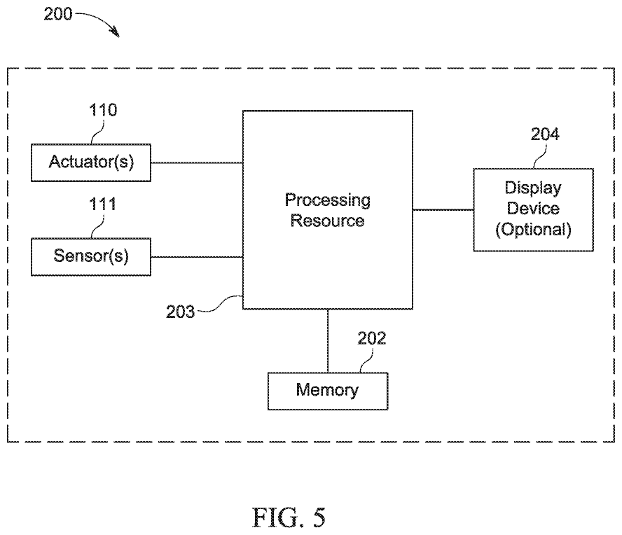

With reference to FIG. 5, the monitoring unit 200 may comprise a memory 202. Further, the monitoring unit 200 may optionally comprise a display device 204.

The at least one processing resource 203 may be configured to process the output of the device 130. The at least one processing resource 203 may be further configured to assess the mechanical health of the device 130 through the output of the device 130 in a current state. In an embodiment, the processing resource 203 may be configured to apply an algorithm comparing the output of the device 130 in a current state against a healthy fingerprint of the device 130 to assess the likelihood of the presence of mechanical defect. A healthy fingerprint may be an output of the device 130 when the system is free of mechanical defects. For example, a healthy fingerprint of a device may be taken immediately following production of the device, when the device is free from mechanical defects and has not experienced any wear.

In an embodiment, the algorithm may be retrieved from the memory 202. Similarly, the healthy fingerprint of the particular device may be retrieved from the memory 202. Additionally, the memory 202 may store the acquired output data of the device 130.

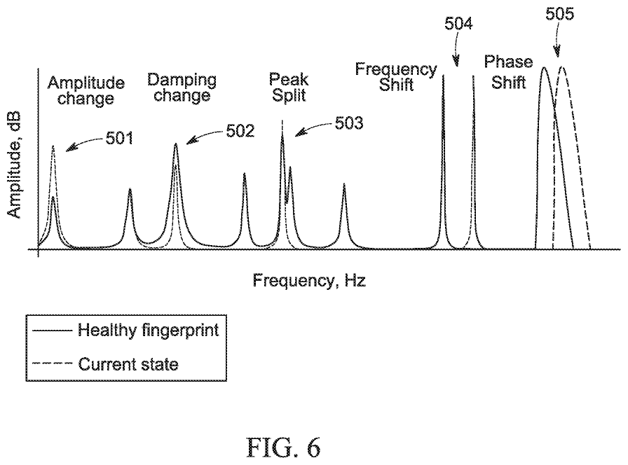

With reference to FIG. 6, in an embodiment, the algorithm may comprise comparing at least one of the amplitude change 501, damping change 502, peak split 503, frequency shift 504 and phase shift 505 of the device 130 in a current state against a healthy fingerprint of the particular device 130.

In an embodiment, the algorithm produces a pass-fail result. For example, the algorithm may be configured to produce a single result which is then compared to a predefined threshold. If the single result of the algorithm is larger or smaller than the predefined threshold, an “unhealthy” result is produced. Conversely, if the single result of the algorithm is within an acceptable range, a “healthy” result is produced. The processing resource 203 may be further configured to provide an output indicating the health of the device 130. For example, if an unhealthy result is produced, the processing resource 203 may be further configured to produce a visual and/or audio indication that the device is in an unhealthy state and that it is likely that the device 130 has one or more mechanical defects. Additionally or alternatively, if a healthy result is produced, the processing resource 203 may be further configured to produce a visual and/or audio indication that the device 130 is in a healthy state.

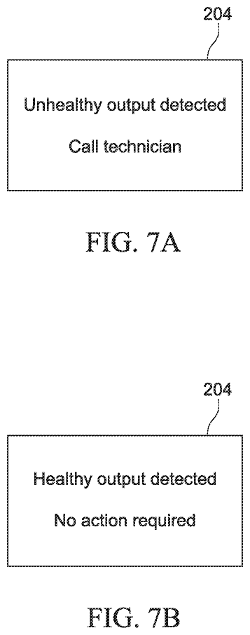

With reference to FIGS. 7A and 7B, in an embodiment, the display device 204 is configured to display the pass-fail results of the algorithm. For example, when an unhealthy result is produced, the display device 204 may provide a visual and/or audio indication that the device 130 is unhealthy. For example, a visual indication shown in FIG. 7A may be displayed on display device 204. Additionally or alternatively, when a healthy result is produced, the display device may provide a visual and/or audio indication that the device 130 is healthy. For example, a visual indication shown in FIG. 7B may be displayed on display device 204.

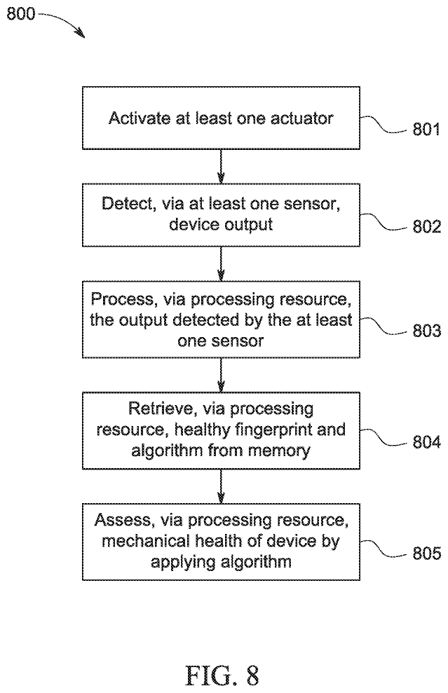

When the monitoring unit 200 is in a run mode, the processing resource 203 sends the signal to the at least one actuator 110 and/or the stimulation source to activate the at least one actuator 110. The processing resource 203 then receives the output detected by the at least one sensor 111, processes the output and assesses the mechanical health of the device 130 based on the output of the device 130 in a current state. The monitoring unit 200 may go into the run mode automatically. For example, the monitoring unit 200 may go into the run mode automatically during start up. Additionally or alternatively, the monitoring unit 200 may go into the run mode automatically at certain time periods. For example, the monitoring unit 200 may go into run mode every hour the device 130 is in use. Additionally or alternatively, the monitoring unit 200 may go into the run mode on demand when commanded by an input. For example, a user may manually command the monitoring device 200 to go into the run mode using one or more input devices (not shown). With reference to FIG. 8, a method 800 for monitoring the mechanical health of a system in accordance with embodiments of the present disclosure is illustrated. The method 800 may be performed on embodiments of the system 100 described above, when the monitoring unit 200 is in run mode. At step 801, at least one actuator 110 coupled to the device 130 is activated. The activation of the at least one actuator 110 may cause the device 130 to vibrate. The at least one actuator 110 may be activated by a stimulation signal via a stimulation source.

In an embodiment, the at least one actuator 110 is activated via a sinusoidal voltage provided by the stimulation source. Additionally or alternatively, the at least one actuator 110 may be activated via an impulse input, step input, linear chirp function, non-linear chirp function, desecrate sine sweep, or any other actuation that achieves the desired bandwidth, provided by the stimulation source. At step 802, the output of the device 130 is detected via the at least one sensor 111 coupled to the device 130. At step 803, the detected output of the device 130 is processed via the processing resource 230. At step 804, the processing resource 203 retrieves the healthy fingerprint of the device 130 and the algorithm from memory 202. At step 805, the processing resource 203 assesses the mechanical health of the device 130 by applying the algorithm retrieved from the memory 202

In an embodiment, the algorithm comprises comparing the output of the device 130 to a healthy fingerprint of the device 130. In a further embodiment the algorithm comprises comparing at least one of the amplitude change, damping change, peak split, frequency shift and phase shift of the output of the device 130 against a healthy fingerprint of the particular device 130.

In an embodiment, the algorithm may be configured to produce a pass-fail result. For example, the algorithm may be configured to produce a single result which is then compared to a predefined threshold. If the single result of the algorithm is larger or smaller than the predefined threshold, an “unhealthy” result is produced. Conversely, if the single result of the algorithm is within an acceptable range, a “healthy” result is produced.

The method 800 may further comprise providing an output indicating the health of the device 130. For example, if an unhealthy result is produced, the processing resource 203 may be further configured to produce a visual and/or audio indication that the device 130 is unhealthy. Additionally or alternatively, if a healthy result is produced, the processing resource 203 may be further configured to produce a visual and/or audio indication that the device 130 is unhealthy. Providing an output indicating the health of the device 130 may comprise displaying a visual indication on the display device 204.

The method 800 may further comprise storing the output data of the device 130 on the memory 202.

As described above, the monitoring unit 200 may go into a run mode automatically. For example, the monitoring unit 200 may go into the run mode automatically during start up. Additionally or alternatively, the monitoring unit 200 may go into the run mode automatically at certain time periods. For example, the monitoring unit 200 may go into run mode every hour the device 130 is in use. Additionally or alternatively, the monitoring unit 200 may go into the run mode on demand when commanded by an input. For example, a user may manually command the monitoring device 200 to go into the run mode using one or more input devices (not shown).

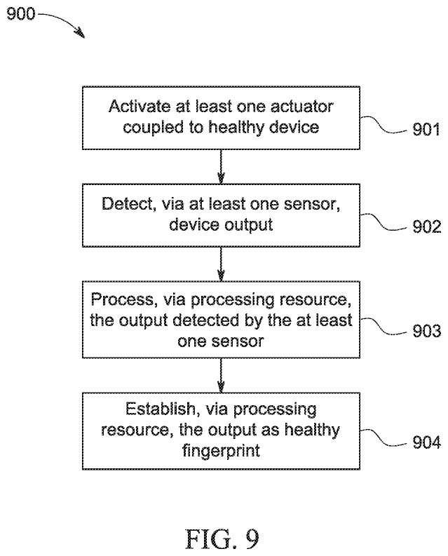

With reference to FIG. 9, a method 900 for determining a healthy fingerprint of the device 130 is illustrated. Method 900 is performed with a system comprising a healthy device. For example, method 900 may be performed on a system immediately following production. At step 901, at least one actuator 110 coupled to the healthy device 130 is activated. The activation of the at least one actuator 110 may cause the healthy device 130 to vibrate. The at least one actuator 110 may be activated via a stimulation source. In an embodiment, the at least one actuator 110 is activated via a sinusoidal voltage provided by the stimulation source. Additionally or alternatively, the at least one actuator 110 may be activated via an impulse input, step input, linear chirp function, non-linear chirp function, desecrate sine sweep, or any other actuation that achieves the desired bandwidth, provided by the stimulation source. At step 902, the output of the device 130 is detected via the at least one sensor 111 coupled to the healthy device 130. At step 903, the output of the device 130 is processed via the processing resource 230. At step 904, the output of the healthy device 130 is established as the healthy fingerprint. The output of the healthy device 130 may be established as the healthy fingerprint manually by the user using one or more input devices (not shown).

In an embodiment, the method 900 further comprises storing the healthy fingerprint of the device 130 in the memory 202 so that it may be retrieved and compared to detected output of the device 130.

As such, the healthy fingerprint may be a unique signature of a particular device. This allows the monitoring unit 200 to be configured for use with a variety of devices.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Although features and elements are described above in particular combinations, one of ordinary skill in the art will appreciate that each feature or element can be used alone or in any combination with the other features and elements.

What is claimed is:

1. A system comprising:
a device;
a monitoring unit comprising:
at least one actuator coupled to the device and configured to vibrate the device;
at least one sensor coupled to the device and configured to detect an output of the device; and
at least one processing resource configured to process the output detected by the at least one sensor and assess the mechanical health of a device through the detected output.

2. The system of claim 1, wherein the at least one processing resource is a dedicated processor coupled to the device.

3. The system of claim 1, wherein the at least one processing resource is an external processor that is external to the device.

4. The system of claim 1, the monitoring unit further comprising a stimulation source configured to supply a stimulation signal to the at least one actuator.

5. The system of claim 1, wherein the at least one actuator and the at least one sensor comprise a single unit.

6. The system of claim 5, wherein the at least one actuator and the at least one sensor comprise a single piezoelectric transducer.

7. The system of claim 1, wherein the processing resource is configured to apply an algorithm comparing the detected output of the device against a healthy fingerprint of the device to assess the mechanical health of the device, wherein the healthy fingerprint is an output of the device when the device is free of mechanical defects.

8. The system of claim 7, wherein the algorithm produces a pass-fail result.

9. The system of claim 8, the monitoring unit further comprising a display device configured to display the pass-fail result.

10. The system of claim 1, wherein the monitoring unit is configured to go into run mode during power up or periodically during use.

11. The system of claim 1, wherein the monitoring unit is configured to go into run mode when commanded by an input.

12. The system of claim 1, wherein the locations of the at least one actuator and the at least one sensor are optimized for obtaining the output of the device.

13. A method for monitoring the mechanical health of a device, the method comprising:
activating at least one actuator configured to cause the device to vibrate;
detecting, via at least one sensor, an output of the device;
processing, via a processing resource, the output detected by the at least one sensor; and
determining, via the processing resource, the mechanical health of a device based on the detected output.

14. The method of claim 13, wherein activating the at least one actuator comprises providing a stimulation signal to the at least one actuator via a stimulation source.

15. The method of claim 13, wherein determining the presence or absence of a mechanical defect comprises applying, via the processing resource, an algorithm to compare the output of the device against a healthy fingerprint of the device, wherein the healthy fingerprint is an output of the device when the device has no mechanical defects.

16. The method of claim 15, wherein the algorithm comprises comparing at least one of the amplitude change, damping change, peak split, frequency shift and phase shift of the output of the device against a healthy fingerprint of the device.

17. The method of claim 15, further comprising retrieving the algorithm and the healthy fingerprint from a memory.

18. The method of claim 15, wherein the algorithm produces a pass-fail result.

19. The method of claim 18, further comprising displaying the pass-fail result on a display device.

20. A non-transitory computer readable medium configured to:
send a signal to activate at least one activator coupled to a device;
receive an output of the device detected by at least one sensor;
process the output of the device;
retrieve an algorithm and a healthy fingerprint of the device from a memory; and
assess the mechanical health of the device by applying the algorithm, wherein the algorithm compares the output of the device detected by the at least one sensor to the healthy fingerprint of the device.
